(19) United States
(12) Patent Application Publication
(10) Pub. No.: US 2024/0367245 A1
(43) Pub. Date: Nov. 7, 2024

(54) BAND SAW

(71) Applicant: MILWAUKEE ELECTRIC TOOL CORPORATION, Brookfield, WI (US)

(72) Inventors: James C. Sitter, Milwaukee, WI (US); Kevin Staszak, New Berlin, WI (US); David A. Bierdeman, New Berlin, WI (US); Kevin R. Gee, New Berlin, WI (US)

(21) Appl. No.: 18/777,151

(22) Filed: Jul. 18, 2024

Related U.S. Application Data
(62) Division of application No. 16/801,679, filed on Feb. 26, 2020, now Pat. No. 12,070,809.
(60) Provisional application No. 62/812,638, filed on Mar. 1, 2019.

(51) Int. Cl. B23D 53/12

(52) U.S. Cl. CPC B23D 53/12

(57) ABSTRACT

A handheld band saw includes a housing, a handle supported by the housing and configured to be grasped by a user during a cutting operation, and a motor supported by the housing. The band saw further includes a drive wheel assembly that is at least partially disposed within the housing and a saw blade driven by the drive wheel assembly. The band saw further includes a drive assembly positioned between the motor and the drive wheel assembly. The drive assembly is configured to transfer torque from the motor to the drive wheel assembly, causing the drive wheel assembly and the saw blade to rotate. The drive wheel assembly includes a wheel having a recess in which a portion of the drive assembly is received to shorten an overall length of the motor, drive assembly, and drive wheel assembly.

### CROSS-REFERENCE TO RELATED APPLICATIONS

This application is a divisional of U.S. patent application Ser. No. 16/801,679, filed on Feb. 26, 2020, which claims priority to U.S. Provisional Patent Application No. 62/812,638, filed Mar. 1, 2019, the entire contents of both of which are incorporated herein by reference.

### BACKGROUND OF THE INVENTION

The present invention relates to a handheld saw, and, more particularly, to a portable band saw. Handheld band saws are used to cut a variety of workpieces, such as pipes, rods, studs, and blocks. A cordless, compact band saw allows for cutting operations in tight spaces or awkward angles for plumbing, electrical, remodeling, and HVAC applications.

### SUMMARY OF THE INVENTION

In one aspect, the invention provides a handheld band saw including a housing, a handle supported by the housing and configured to be grasped by a user during a cutting operation, and a motor supported by the housing. The band saw further includes a drive wheel assembly that is at least partially disposed within the housing. The band saw further includes a saw blade driven by the drive wheel assembly and configured to cut a workpiece during the cutting operation. The band saw further includes a drive assembly positioned between the motor and the drive wheel assembly. The drive assembly is configured to transfer torque from the motor to the drive wheel assembly, causing the drive wheel assembly and the saw blade to rotate. The drive wheel assembly includes a wheel having a recess in which a portion of the drive assembly is received to shorten an overall length of the motor, drive assembly, and drive wheel assembly.

In another aspect, the invention provides a handheld band saw, including a housing having a handle and a motor cover, a motor supported by the housing and enclosed at least partially by the motor cover, and a drive wheel and a driven wheel that is driven by the drive wheel via a saw blade. The band saw further includes a drive wheel spindle positioned between the motor and the drive wheel for transferring torque from the motor to the drive wheel, and a first bearing supporting the drive wheel spindle for rotation and a second bearing supporting the motor for rotation. The drive wheel has a recess in which a portion of the first bearing is received to shorten an overall length between the motor and the drive wheel.

### BRIEF DESCRIPTION OF THE DRAWINGS

FIG. 1 is a perspective view of a handheld band saw.

FIG. 2 is an exploded view of a drive wheel assembly of the band saw of FIG. 1, illustrating a pipe reamer attachment removably attached thereto.

FIG. 3 is an exploded view of an alternative embodiment of a drive wheel assembly of the band saw of FIG. 1, illustrating a pipe reamer attachment removably attached thereto.

FIG. 4 is a cross-sectional view of yet another embodiment of a drive wheel of the band saw of FIG. 1, illustrating a pipe reamer attachment removably attached thereto.

FIG. 5 is perspective view of a shoe of the band saw of FIG. 1, illustrating a slide mechanism that enables the shoe to move along a shoe axis.

FIG. 6 is an enlarged plan view of the slide mechanism of FIG. 5, illustrating a detent mechanism of the slide mechanism.

FIG. 7 is a cross-sectional view of a motor of the band saw taken along line 7-7 of FIG. 1.

FIG. 8 is a perspective view of the motor of the band saw, illustrating a recess within a motor fan.

FIG. 9 is a plan view of the motor of FIG. 8.

### DETAILED DESCRIPTION

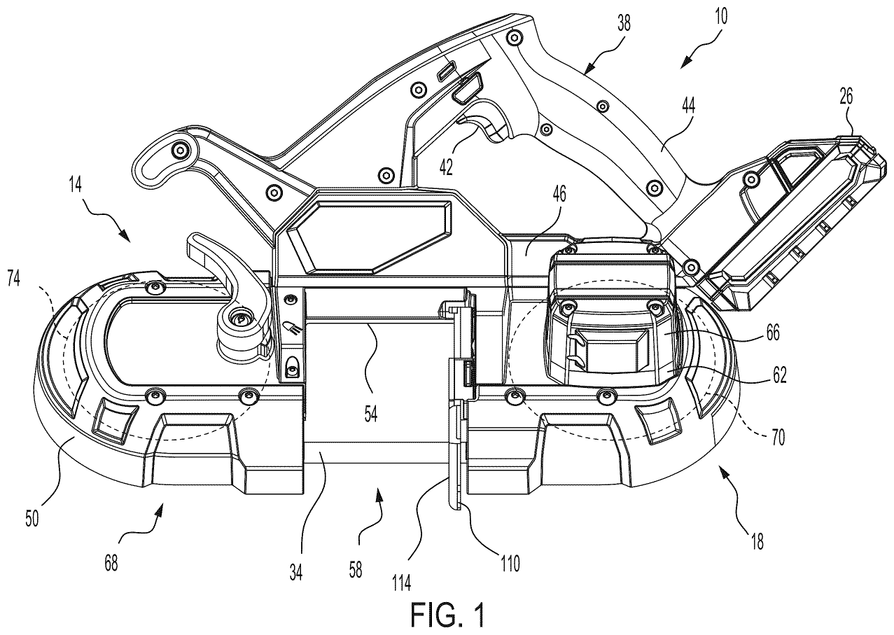

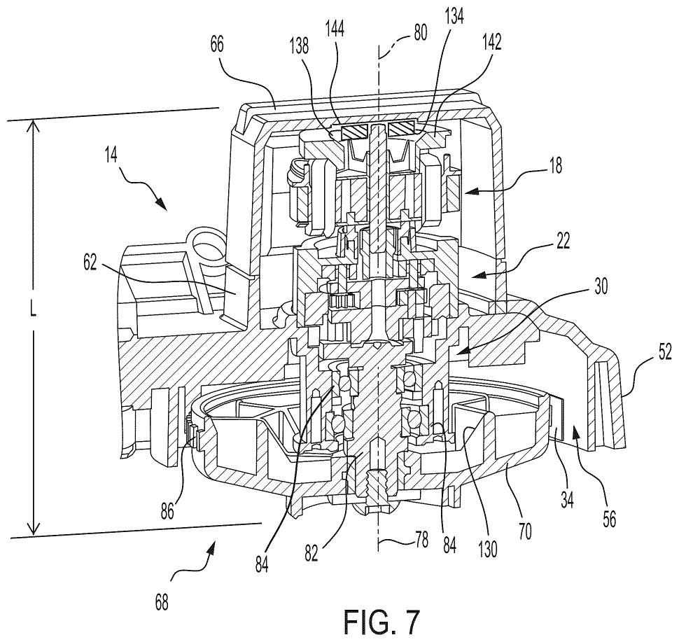

FIG. 1 illustrates a band saw 10 including a frame or housing 14 supporting a motor 18 and a gear box 22 (FIG. 7). In the illustrated construction of the band saw 10, the motor 18 is configured as a DC brushless motor, and the band saw 10 includes a removable, rechargeable battery 26 for supplying power to the band saw 10. The motor 18 is drivingly connected to a drive assembly 30 through a gear box 22. The motor 18, the drive assembly 30, and the gear box 22 are supported by the housing 14. The drive assembly 30 may include any of a number of bearing arrangements and different gear train arrangements configured to provide a low-speed, high-torque output from the high-speed, low-torque input provided by the motor 18. The motor 18 and the drive assembly 30 are operable to drive a continuous band saw blade 34 to cut a workpiece (FIG. 1).

With continued reference to FIG. 1, the housing 14 includes a main handle 38 with a trigger 42 to provide power to the band saw 10. The trigger 42 is disposed adjacent a gripping portion 44 of the handle 38 where a user grasps the band saw 10. In the illustrated construction of the band saw 10, the battery 26 is supported by the main handle 38 and is an 18-volt power tool battery 26. In other embodiments, the battery 26 may be supported on the housing 14. The trigger 42 is operable to control operation of the motor 18. Specifically, the battery 26 selectively supplies power to the motor 18 when the trigger 42 is actuated. The housing 14 of the band saw 10 also includes a deck 46 and a guard 50 coupled to the deck 46. A combination of the deck 46 and the guard 50 defines an opening or U-shaped cavity 54. The guard 50 includes a lip 52 that provides a recessed area 56 (FIG. 7) in which the band saw blade 34 is positioned. The guard 50 substantially covers the band saw blade 34 when the blade 34 is in a shielded position (i.e., when the blade 26 is outside of a cut zone 58; FIG. 1). However, the U-shaped cavity 54 enables the band saw blade 34 to be in an exposed position (i.e., when the blade 26 passes through the cut zone 58; FIG. 1). In the exposed position, the blade 34 is fully exposed and unobstructed by the guard 50, allowing workpieces to be cut when entering the cut zone 58.

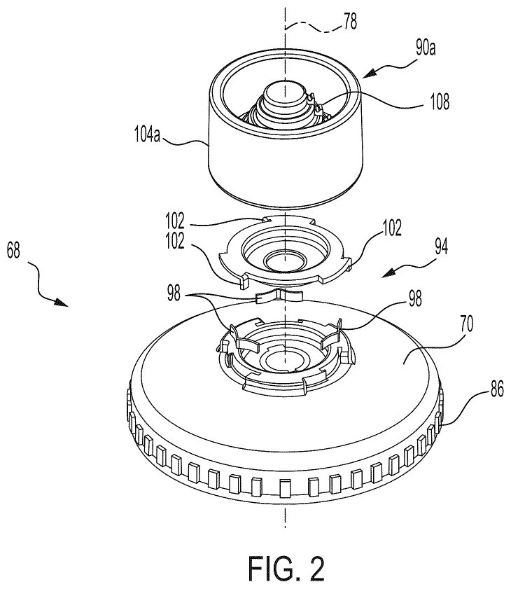

With reference to FIGS. 1-4, the deck 46 includes a motor support portion 62 and a separate motor cover 66 that together enclose the motor 18. The band saw 10 further includes a drive wheel assembly 68 that supports and drives the saw blade 34. The drive wheel assembly 68 includes a drive wheel 70 that is directly driven by the motor 18 and a driven wheel 74 that is driven by the drive wheel 70 via the saw blade 34. The outer peripheral surface and the interior side of the drive wheel 70 and the driven wheel 74 are covered by the deck 46 and the guard 50. The drive wheel 70 rotates about a drive wheel axis 78 (FIGS. 2-4) defined by a drive wheel spindle 82 (FIG. 7). The drive wheel spindle 82 is rotationally supported by bearings 84 of the drive assembly 30. The drive wheel 70 is drivingly connected to the motor 18 via the gear box 22, the drive assembly 30, and the drive wheel spindle 82. In the illustrated construction of the band saw 10, the rotational axis 80 of the motor 18 is coaxially aligned with the drive wheel axis 78. In other embodiments, the rotational axis 80 and the drive wheel axis 78 may be parallel or at some other oblique angle relative to each other. A tire 86 is coupled to the outer peripheral surface of each of the wheels 70, 74 (although only one of which is shown). Each tire 86 grips the saw blade 34 to drive motion thereof.

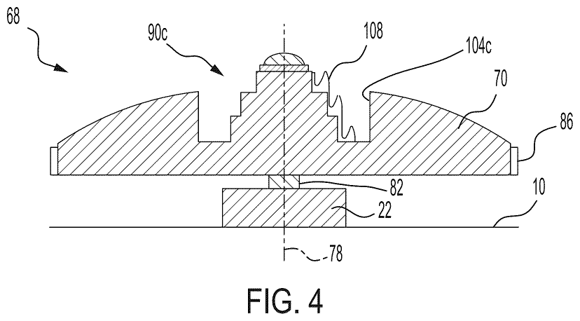

With reference to FIG. 2, the band saw 10 further includes a pipe reamer attachment 90a that is coupled to and driven by the drive wheel assembly 68. Although the pipe reamer attachment 90a of the illustrated embodiment is coupled to the drive wheel 70, in other embodiments, the pipe reamer attachment 90a may alternatively be coupled to the driven wheel 74. With the pipe reamer attachment 90a being coupled to the band saw 10, a user can both cut and ream (i.e., deburr) a pipe with a single tool. In one embodiment, the pipe reamer attachment 90a is removably coupled to the drive wheel 70, while in other embodiments, the pipe reamer attachment 90a may be permanently coupled to or integrated as part of the drive wheel 70 (FIG. 4). In this embodiment, the pipe reamer attachment 90a is coupled to the drive wheel 70 via a quick disconnect coupling 94, as shown in FIG. 2. The quick disconnect coupling 94 includes spring detents 98 that mechanically interface with corresponding projections 102 to maintain the pipe reamer attachment 90a on the drive wheel 70. More specifically, when attaching the pipe reamer attachment 90a to the drive wheel 70, the projections 102 slide along the spring detents 98 to temporarily deform (i.e., flex) the spring detents 98. Once the projections 102 slide beyond the spring detents 98, the spring detents 98 rebound and create a mechanical interference between the projections 102 and the spring detents 98 to inhibit the piper reamer attachment 90a from being removed from the drive wheel 70. During a reaming operation, the drive wheel 70 is driven, for example, in a clockwise direction, while the pipe reamer attachment 90a is coupled to the drive wheel 70 by rotating the pipe reamer attachment 90a, for example, in a counter-clockwise direction so as to inhibit the pipe reamer attachment 90a from disconnecting from the drive wheel 70 during operation. The pipe reamer attachment 90a includes an annular shroud 104a that accommodates pipe ranging from ⅓ inches in diameter to 1 inch in diameter. In other embodiments, the pipe reamer attachment 90a may accommodate pipe having a different diameter.

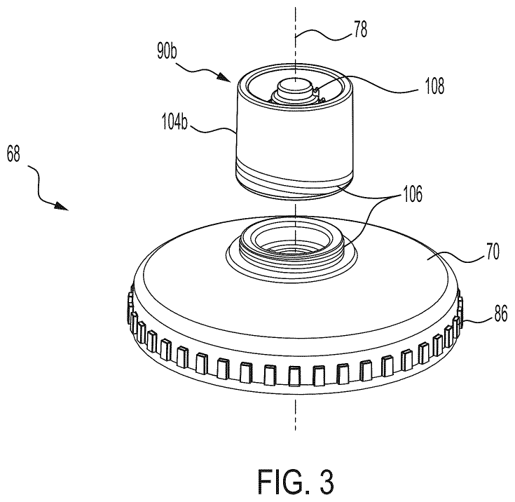

FIG. 3 illustrates another embodiment of a pipe reamer attachment 90b that is coupled to the drive wheel 70 via a helical thread pattern 106. Specifically, the drive wheel 70 includes a helical thread pattern 106 that engages with a corresponding thread pattern 106 on the piper reamer attachment 90b. Again, the pipe reamer attachment 90b is rotatably coupled to the drive wheel 70 in an opposite direction of the direction of rotation of the drive wheel 70 to inhibit the pipe reamer attachment 90b from disconnecting from the drive wheel 70 during operation. The pipe reamer attachment 90b includes an annular shroud 104b that accommodates pipe ranging from ⅓ inches in diameter to 1 inch in diameter. In other embodiments, the pipe reamer attachment 90b may accommodate pipe having a different diameter.

FIG. 4 illustrates yet another embodiment of a pipe reamer attachment 90c that is integrated as part of the drive wheel 70. In other words, the pipe reamer attachment 90c and the drive wheel 70 are formed as a single component that is directly coupled to the drive wheel spindle 82. The pipe reamer attachment 90c may also be recessed within the drive wheel 70, such that the pipe reamer attachment 90c does not extend or extends only slightly beyond the drive wheel 70, as shown in FIG. 4. Still, the pipe reamer attachment 90c includes an annular shroud 104c that accommodates pipe ranging from ⅓ inches in diameter to 1 inch in diameter. In other embodiments, the pipe reamer attachment 90c may accommodate pipe having a different diameter.

Each pipe reamer attachment 90a, 90b, 90c includes a blade 108 for engaging and removing a burr formed on the end of a pipe after the blade 34 has cut the pipe. The blade 108 is disposed within the annular shroud 104a, 104b, 104c to prevent the blade 108 from being exposed from the exterior of the shroud 104a, 104b, 104c. The blade 108 of the illustrated embodiment is a multi-tiered blade, where each tier is capable of engaging a different sized pipe, such as pipes ranging from ⅓ inches in diameter to 1 inch in diameter. In other embodiments, the blade 108 may alternatively be three separate blades.

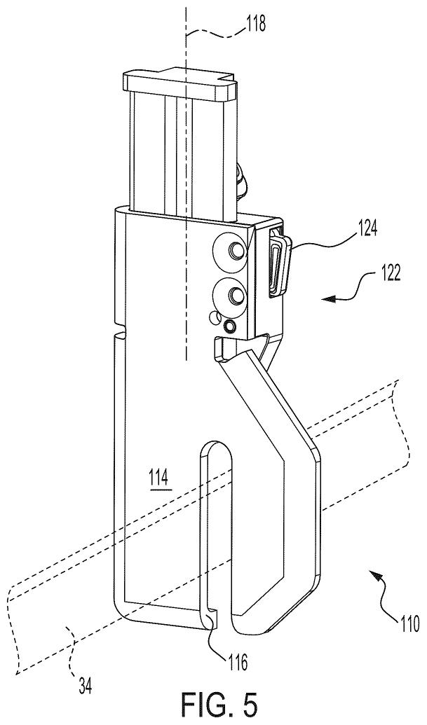

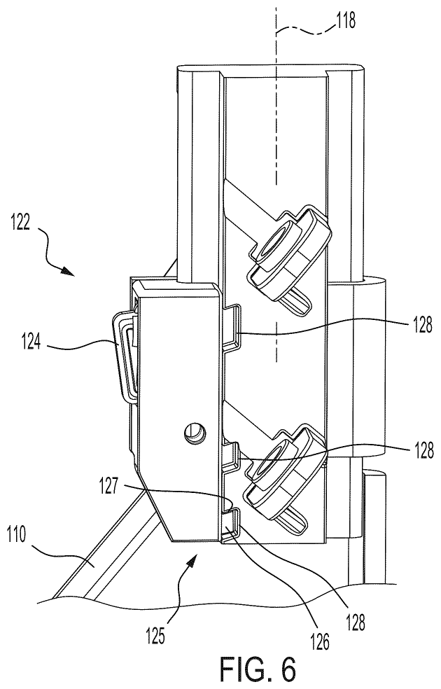

With reference to FIGS. 5 and 6, the band saw 10 further includes a shoe 110 having a support surface 114 against which a workpiece is abutted during a cutting operation and a slot 116 through which the saw blade extends. The shoe 110 is adjacent the cut zone 58. The shoe 110 is adjustable along a shoe axis 118 that extends substantially parallel with the saw blade 34. By adjusting the shoe 110 along the shoe axis 118, the support surface 114 is moveable to support and accommodate pipes of varying diameters. The shoe 110 includes a slide mechanism 122 with an actuator 124 that, when depressed, allows a user to move the shoe 110 between a retracted position and an extended position along the shoe axis 118. The slide mechanism 122 maintains the shoe 110 in different predefined positions between the retracted and extended positions via a detent mechanism 125 (FIG. 6). Specifically, the detent mechanism 125 includes a tooth 126 that is actuated via the actuator 124, and a plurality of notches 128 that selectively receive the tooth 126 to maintain the shoe 110 in various predefined positions. When the tooth 126 is in an extended position (as shown in FIG. 6), the tooth is received in one of the notches 128 and inhibits the shoe 110 from moving along the shoe axis 118. In contrast, when the tooth 126 is in a retracted position, the tooth 126 is removed from one of the notches 128 thereby enabling the shoe 110 to move along the shoe axis 118.

However, the detent mechanism 125 is designed in a cam-like manner such that the tooth 126 has a cam surface 127 shaped to permit the tooth 126 to be removed from the notch 128, without depressing the actuator 124, and moved to the retracted position when a sufficient upward force is exerted on the shoe 110 (from the frame of reference of FIGS. 5 and 6). In this case, the shoe 110 retracts to the retracted position in response to a sufficient force being exerted upon the shoe 110. An impact force proportionate to dropping the band saw 10 from a distance greater than approximately two inches above a ground surface is sufficient to cause the shoe 110 to retract to the retracted position when the impact force is exerted on the shoe 110. The resulting impact force exerted upon the shoe 110 overcomes the biasing force of the detent mechanism 125, allowing the shoe 110 to retract via the slide mechanism 122. When the band saw 10 is dropped from a distance less than approximately two inches above a ground surface, the shoe 110 remains in position without retracting to the retracted position because the impact force exerted on the shoe 110 is not sufficient to overcome the biasing force of the detent mechanism 125. The slide mechanism 122 is designed to avoid causing damage to the shoe 110 when the band saw 10 is inadvertently dropped.

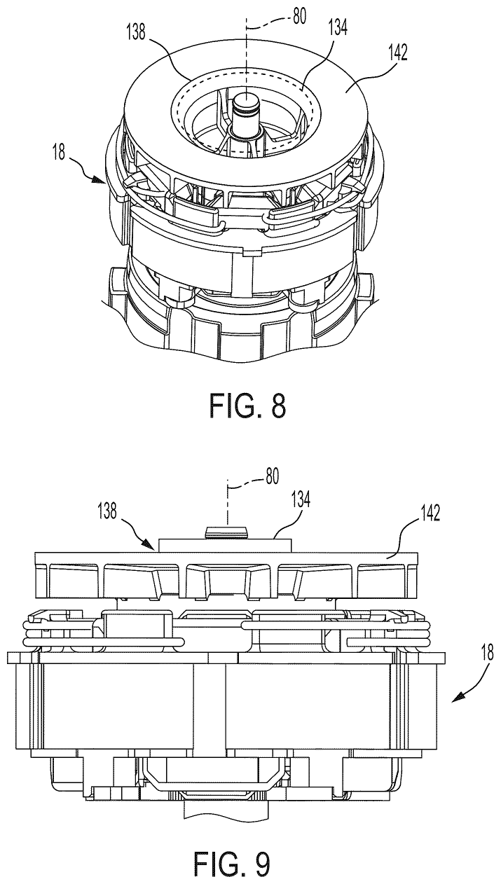

With reference to FIGS. 7-9, the drive wheel 70 further includes a recess 130 on the interior side adjacent the motor 18. The recess 130 accommodates a portion of the drive assembly 30, as shown in FIG. 7. Also, a top rotor bearing 134 is accommodated within a recess 138 of a motor fan 142, as shown in FIGS. 7-9, and mounted within a corresponding pocket 144 in the motor cover 66 (FIG. 7). As such, the motor cover 66 and the motor fan 142 are spaced apart just enough to avoid mechanical interference, but the gap therebetween is otherwise negligible. The purpose of the recess 130 and the recess 138 is to consolidate the configuration of the motor 18, the gearbox 22, and the drive assembly 30 as much as possible so the motor cover 66 protrudes from the deck 46 as little as possible. By reducing the overall length L between the motor 18, and the drive wheel assembly 68 measured along the rotational axis 80, the band saw 10 is more ergonomic and reduces torque exerted on a user during a cutting and reaming operation. In some embodiments, the overall length L is between 2 inches and 3 inches. And, in some embodiments, the overall length is no more than 2.5 inches.

Various features of the invention are set forth in the following claims.

What is claimed is:

1. A handheld band saw, comprising:
a housing;
a handle supported by the housing and configured to be grasped by a user during a cutting operation;
a motor supported by the housing;
a drive wheel assembly at least partially disposed within the housing;
a saw blade driven by the drive wheel assembly and configured to cut a workpiece during the cutting operation; and
a drive assembly positioned between the motor and the drive wheel assembly, wherein the drive assembly is configured to transfer torque from the motor to the drive wheel assembly, causing the drive wheel assembly and the saw blade to rotate,
wherein the drive wheel assembly includes a wheel having a recess in which a portion of the drive assembly is received to shorten an overall length of the motor, the drive assembly, and the drive wheel assembly.

2. The handheld band saw of claim 1, wherein the wheel surrounds the portion of the drive assembly that is recessed within the recess.

3. The handheld band saw of claim 2, wherein the drive assembly includes a spindle to which the wheel is coupled for co-rotation and a first bearing that rotatably supports the spindle, and wherein the first bearing is at least partially received within the recess in the wheel.

4. The handheld band saw of claim 3, wherein the wheel surrounds the first bearing that rotatably supports the spindle.

5. The handheld band saw of claim 2, further comprising:
a second bearing rotatably supporting a rotor of the motor; and
a fan driven by the motor, wherein the fan includes a recess in which the second bearing is at least partially received to shorten the overall length of the motor, the drive assembly, and the drive wheel assembly.

6. The handheld band saw of claim 5, wherein the overall length of the motor, the drive assembly, and the drive wheel assembly is between 2 inches and 3 inches.

7. The handheld band saw of claim 5, wherein the overall length of the motor, the drive assembly, and the drive wheel assembly is approximately 2.5 inches.

8. The handheld band saw of claim 1, wherein the housing includes a deck that at least partially covers the wheel, and wherein the deck includes a motor support portion and a separate motor cover that together enclose the motor.

9. The handheld band saw of claim 8, wherein the motor cover extends from the deck.

10. The handheld band saw of claim 1, further comprising a battery removably coupled to the handle, wherein the battery, when coupled to the handle, is configured to provide power to the motor.

11. The handheld band saw of claim 10, further comprising a trigger disposed adjacent a gripping portion of the handle, wherein power from the battery is supplied to the motor when the trigger is actuated.

12. A handheld band saw, comprising:
a housing having a handle and a motor cover;
a motor supported by the housing and enclosed at least partially by the motor cover;
a drive wheel and a driven wheel that is driven by the drive wheel via a saw blade;
a drive wheel spindle positioned between the motor and the drive wheel for transferring torque from the motor to the drive wheel; and
a first bearing supporting the drive wheel spindle for rotation and a second bearing supporting the motor for rotation,
wherein the drive wheel has a recess in which a portion of the first bearing is received to shorten an overall length between the motor and the drive wheel.

13. The handheld band saw of claim 12, further comprising a fan coupled to and driven directly by the motor, wherein the second bearing is mounted within a pocket of the motor cover.

14. The handheld band saw of claim 13, wherein the recess of the drive wheel is a first recess, and wherein the handheld band saw further includes a second recess defined in the fan in which a portion of the second bearing is accommodated.

15. The handheld band saw of claim 14, wherein the first bearing is received within the first recess of the drive wheel and the second bearing is received within the second recess of the fan to shorten an overall length measured from the motor to the drive wheel.

16. The handheld band saw of claim 15, wherein the overall length between the motor and the drive wheel is between 2 inches and 3 inches.

17. The handheld band saw of claim 15, wherein the overall length between the motor and the drive wheel is approximately 2.5 inches.

18. The handheld band saw of claim 17, wherein the drive wheel is drivingly connected to the motor via a gear box and the drive wheel spindle, and wherein the gear box is disposed between the motor and the drive wheel.

19. The handheld band saw of claim 12, wherein the drive wheel surrounds the portion of the first bearing that is received within the recess.

20. The handheld band saw of claim 12, further comprising a battery removably coupled to the handle, wherein the battery, when coupled to the handle, is configured to provide power to the motor.
